(19) United States
(12) Patent Application Publication
(10) Pub. No.: US 2012/0204566 A1
(43) Pub. Date: Aug. 16, 2012

(54) FRESNEL LENS

(76) Inventors: Andrew K. Hartzell, Hudson, WI (US); James M. Jonza, Woodbury, MN (US); Michael A. Johnson, Stillwater, MN (US); Olester Benson, Woodbury, MN (US)

(21) Appl. No.: 13/503,512

(22) PCT Filed: Oct. 18, 2010
(86) PCT No.: PCT/US10/53012

§ 371 Date: Apr. 23, 2012

(30) Foreign Application Priority Data
Oct. 26, 2009 (US) 61254910

(51) Int. Cl. F03G 6/06; C09J 177/10; B05D 5/06; G02B 13/14; G02B 3/08

(52) U.S. Cl. 60/641.15; 359/355; 427/164; 156/331.7

(57) ABSTRACT

Fresnel lenses are prepared from a transparent substrate and a structured polyurethane layer. The structured polyurethane layer includes a curable reaction mixture. The curable reaction mixture includes a polyol, a polyisocyanate, a catalyst, and at least one UV stabilizer. The Fresnel lenses may be used in panel arrays and in solar power generation devices.

### FIELD OF THE DISCLOSURE

The present disclosure relates to Fresnel lenses, methods of making Fresnel lenses and devices utilizing Fresnel lenses.

### BACKGROUND

A Fresnel lens is a lightweight and compact flat lens constructed by replacing the curved surface of a convex lens or a concave lens with a series of discontinuous surfaces formed by prisms arranged concentrically or in parallel, thereby reducing the lens thickness to the minimum required to achieve the necessary curved surface. This greatly reduces the weight of the lens.

Fresnel lenses are widely used to convert a light beam from a point light source into a parallel beam of light, such as the lens used with a backlight in a liquid crystal display, or conversely to concentrate a parallel beam of light into a defined beam, such as a condensing lens used in a solar power generating system. Additionally, Fresnel lenses can be used as light spreaders. Light spreaders are used for example in illuminated signs where a single light source can replace multiple light sources by using a light spreader.

### SUMMARY

In one embodiment, the present disclosure provides a Fresnel lens comprising a transparent substrate and a structured polyurethane layer, wherein the structured polyurethane layer comprises an at least partially cured reaction mixture. The reaction mixture comprises a polyol, a polyisocyanate, a catalyst, and at least one UV stabilizer.

Methods for preparing Fresnel lenses are disclosed. In one embodiment the methods comprise providing a transparent substrate with a first surface and a second surface, providing a curable reaction mixture, providing a structuring tool, preparing a laminate construction comprising a transparent substrate and a curable reaction mixture, curing the reaction mixture, and removing the structuring tool. The curable reaction mixture comprises a polyol, a polyisocyanate, a catalyst, and at least one UV stabilizer.

In another embodiment, the methods comprise providing a curable reaction mixture, providing a structuring tool with a structured surface, contacting the curable reaction mixture to the structured surface of the structuring tool, curing the reaction mixture, providing a transparent substrate with a first surface and a second surface, adhesively bonding the cured reaction mixture to the first surface of the transparent substrate, and removing the structuring tool. The curable reaction mixture comprises a polyol, a polyisocyanate, a catalyst, and at least one UV stabilizer.

Also disclosed is an optical array comprising a plurality of Fresnel lenses, wherein at least one Fresnel lens comprises a transparent substrate and a structured polyurethane layer. The structured polyurethane layer comprises an at least partially cured reaction mixture, where the reaction mixture comprises a polyol, a polyisocyanate, a catalyst, and at least one UV stabilizer.

A solar power generation device is also disclosed. The solar power generation device comprises a Fresnel lens and a solar light convertor. The Fresnel lens comprises a transparent substrate, and a structured polyurethane layer. The structured polyurethane layer comprises an at least partially cured reaction mixture. The reaction mixture comprises a polyol, a polyisocyanate, a catalyst, and at least one UV stabilizer.

### BRIEF DESCRIPTION OF THE DRAWINGS

FIG. 1 shows a cross sectional view of an exemplary Fresnel lens.

FIG. 2 shows a cross sectional view of an exemplary Fresnel lens.

FIG. 3 shows a cross sectional view of an exemplary Fresnel lens wherein the Fresnel lens is a positive lens.

### DETAILED DESCRIPTION

The present disclosure provides Fresnel lenses, methods of preparing Fresnel lenses and devices which use Fresnel lenses. Despite the widespread use of Fresnel lenses, the need remains for lenses which can be easily and reproducibly fabricated, and can be economically prepared on a large scale from materials which have desirable weathering properties. Among the weathering properties are, for example, exposure to heat and ultraviolet (UV) radiation, such as a lens would be exposed to in an outdoor environment. This is particularly important for uses such as solar concentration in solar power generating systems.

The term “transparent substrate” as used herein, refers to substrates that have a high light transmission (typically greater than 90%) over at least a portion of the surface of the substrate over at least a portion of the light spectrum with wavelengths of about 350 to about 1600 nanometers, including the visible light spectrum (wavelengths of about 380 to about 750 nanometers).

The term “polyurethane” as used herein refers to polymers prepared by the step-growth polymerization of hydroxyl-functional materials (materials containing hydroxyl groups —OH) with isocyanate-functional materials (materials containing isocyanate groups —NCO) and therefore contain urethane linkages (—O(CO)—NH—), where (CO) refers to a carbonyl group (C═O). The term is also intended to include “polyurethane-ureas” in which both urethane linkages and urea linkages are present. Urea linkages are formed from the reaction of amine-functional materials (materials containing amine groups with at least one active hydrogen such as —NH₂ (primary amine) and —NHR (secondary amine) where R is an alkyl, aryl, or related group) and an isocyanate-functional material and have the general structure —NR(CO)—NH—, where R is a hydrogen, alkyl, aryl, or related group.

The term “curing” as used herein, refers to polymerization, in this case step-growth polymerization, to form a polymer. Typically, curing refers to complete polymerization of the curable mixture, but may include at least partial curing. This polymerization may include crosslinking in which adjacent polymer chains are linked together to form a single polymeric material. This crosslinking may be achieved through the selection of reactants (e.g. use of one or more reactants that is greater than difunctional) or by processing steps such as for example exposure to an electron beam (E-beam crosslinking).

The term “structured” as used herein, refers to a surface, the surface comprising a series of features and wherein at least one of the feature dimensions (height, width and length) is greater than 10 micrometers. Two or even all three of the feature dimensions (height, width, length) may be greater than 10 micrometers. Typically, the structures are less than 1 millimeter in at least one dimension, more typically less than 1 millimeter in all of the feature dimensions. The structures may additionally comprise features of less than 10 micrometers.

The term “point-focus lens” as used herein, refers to lenses which concentrate incoming light, such as sunlight, into a point. Such a lens is typically used in solar applications to focus light into the aperture of a single photovoltaic cell or secondary optic. Point-focus lenses may be designed so that the focused point fills these apertures to varying degrees and in varying uniformity.

The term “line-focus lens” as used herein, refers to lenses which concentrate incoming light, such as sunlight, into a line. Such lenses are typically used in solar applications to focus light onto a strip of photovoltaic cells or in solar thermal applications to focus light onto pipes or other heat collection devices.

The term “positive lens” as used herein, refers to a lens which causes an incident optical wavefront to increase its convergence. In the case of a collimated beam of light with a planar wavefront, the light is focused to a spot on the optical axis at a certain distance behind the lens, known as the lens focal length. Positive lenses are also sometimes called “converging lenses”.

The term “negative lens” as used herein, refers to a lens which causes an incident optical wavefront to increase its divergence. In the case of a collimated beam of light with a planar wavefront, the light is diffused and does not come to a focus behind the lens. Negative lenses are also sometimes called “diverging lenses”.

The term “adhesive” as used herein refers to polymeric compositions useful to adhere together two adherends. Examples of adhesives are heat activated adhesives, structural adhesives and pressure sensitive adhesives.

Heat activated adhesives are non-tacky at room temperature but become tacky and capable of bonding to a substrate at elevated temperatures. These adhesives usually have a Tg or melting point (Tm) above room temperature. When the temperature is elevated above the Tg or Tm, the storage modulus usually decreases and the adhesive becomes tacky.

Structural adhesives refer to adhesives that that can bond other high strength materials (e.g., wood, composites, or metal) so that the adhesive bond strength is in excess of 6.0 MPa (1000 psi).

Pressure sensitive adhesive (PSA) compositions are well known to those of ordinary skill in the art to possess properties including the following: (1) aggressive and permanent tack, (2) adherence with no more than finger pressure, (3) sufficient ability to hold onto an adherend, and (4) sufficient cohesive strength to be cleanly removable from the adherend. Materials that have been found to function well as PSAs are polymers designed and formulated to exhibit the requisite viscoelastic properties resulting in a desired balance of tack, peel adhesion, and shear holding power. Obtaining the proper balance of properties is not a simple process.

Fresnel lenses of the present disclosure comprise a transparent substrate, and a structured polyurethane layer. The structured polyurethane layer comprises an at least partially cured reaction mixture in which the curable reaction mixture includes a polyol, a polyisocyanate, a catalyst and at least one UV stabilizer. Typically, the structured polyurethane layer is fully cured and may be crosslinked either by the choice of reactants or by a post-curing process such as E-beam crosslinking.

The transparent substrate provides a support surface for the structured polyurethane layer and a wide variety of transparent substrates may be used. Examples of materials suitable for use in the transparent substrate include both inorganic and organic materials such as, for example, glass, polymethylmethacrylate, polycarbonate, polyamides, polyesters, and polycyclic olefin copolymers.

Typically, the transparent substrate is planar. The transparent substrate may be of various thicknesses depending upon the type of materials used as well as the desired use for the formed lens. For example, the transparent substrate may be any suitable thickness up to 2.54 centimeters (one inch) thick, but generally is thinner to reduce the total weight of the lens. The transparent substrate is typically in the range of about 2 to about 8 millimeters thick, especially for solar applications.

The transparent substrate may also provide protection to the structured polyurethane layer in certain uses. For example, if the Fresnel lens is to be used to concentrate solar light in solar power generating system, the transparent substrate can be on the “outside” of the lens, facing the environment. This protects the structured polyurethane layer from impacts from dust, rain and hail for example on terrestrial solar power generation systems and meteorite and dust impacts in space-based solar power generation systems.

If desired, the transparent substrate may be used as supplied or it may be modified, as long the modifications do not significantly reduce the transparency of the substrate. For example, a primer or other surface treatment may be used to make the surface of the transparent substrate which will contain the structured polyurethane layer more receptive to the attachment of the structured polyurethane layer. For example, it may be desirable to apply a compound such as coupling agent to the surface of the transparent substrate. Coupling agents are bifunctional molecules in which the different functionalities interact with different environments. A suitable example is an amino silane such as 3-aminopropyl-trimethoxysilane, which is commercially available from Momentive Performance Materials as SILQUEST A-1170. In this example, the amino group can co-react with the forming urethane polymer and the silane can interact with a glass surface.

Additionally, the surface of the transparent substrate that will not contain the structured polyurethane layer may also be modified. For example, hard coats, scratch resistant coatings, anti-fog coatings, anti-graffiti coatings and the like may be applied to protect the surface of the transparent substrate. Such coatings may be applied as pre-formed films that are adhered to the surface or as reactive coatings which are subsequently cured.

The Fresnel lenses of the present disclosure also comprise a structured polyurethane layer. This polyurethane layer is prepared from the step-growth polymerization of a reaction mixture that comprises a polyol, a polyisocyanate, and a catalyst. The reaction mixture may also contain additional components which are not step-growth polymerizable, and generally contain at least one UV stabilizer. As will be described below, the step-growth polymerization reaction, or curing, generally is carried out in a mold or tool to generate the structured surface in the cured surface.

Because the polyurethane polymers described in this disclosure are formed from the step-growth reaction of a polyol and a polyisocyanate they contain at least polyurethane linkages. The polyurethane polymers formed in this disclosure may contain only polyurethane linkages or they may contain other optional linkages such as polyurea linkages, polyester linkages, polyamide linkages and the like. As described below, these other optional linkages can appear in the polyurethane polymer because they were present in the polyol or the polyisocyanate materials that are used to form the polyurethane polymer. The polyurethane polymers of this disclosure are essentially free from linkages formed from free radical polymerizations. For example, polyurethane oligomeric molecules with vinylic or other free radically polymerizable end groups are known materials, and polymers formed by the free radical polymerization of these molecules are sometimes referred to as “polyurethanes”, but such polymers are outside of the scope of this disclosure.

The use of curable systems to form optical devices such as lenses can be problematic due to the fact that the curable system increases in density upon curing, and this increase in density corresponds to a shrinkage of volume during curing. This shrinkage can lead to residual stress in the cured article which can cause optical defects such as high birefringence. The residual stress can be mitigated through the use of a step-growth polymerization system. Step-growth polymerization processes are well known organic chemical reactions in which organic functional groups possessing a complimentary reactive relationship (like isocyanates and alcohols) react to form a covalent bond either by functional group rearrangement (such as the formation of the urethane linkage) or by elimination of a small molecule such as water. The curing of polyurethanes to form a structured layer such as a Fresnel lens is desirable because the reaction to form the polyurethane is step-growth polymerization. However, cured polyurethanes can be difficult to utilize in precision molding applications because the cured polyurethane can be difficult to remove from the mold.

Typically the structured polyurethane layer is of a sufficient size to produce the desired optical effect. The polyurethane layer is generally no more than 10 millimeters thick, typically much thinner. In order to form an economical lens, it is generally desirable to use a structured polyurethane layer which is as thin as possible. It may be desirable to maximize the amount of polyurethane material which is contained in the structures and to minimize the amount of polyurethane material that forms the base of the structured polyurethane layer but is not structured. In some instances this base portion is sometimes referred to as “the land” as it is analogous to the land from which mountains arise. Since the structures are at least 10 micrometers in at least one dimension, the polyurethane layer is at least 10 micrometers thick in at least one point on the lens.

A wide variety of polyols may be used in the curable reaction mixture that forms the structured polyurethane layer. The term polyol includes hydroxyl-functional materials that generally comprise at least 2 terminal hydroxyl groups. Polyols include diols (materials with 2 terminal hydroxyl groups) and higher polyols such as triols (materials with 3 terminal hydroxyl groups), tetraols (materials with 4 terminal hydroxyl groups), and the like. Typically the reaction mixture contains at least some diol and may also contain higher polyols. Higher polyols are particularly useful if crosslinked polyurethane polymers are desired. Diols may be generally described by the structure HO—B—OH, where the B group may be an aliphatic group, an aromatic group, or a group containing a combination of aromatic and aliphatic groups, and may contain a variety of linkages or functional groups, including additional terminal hydroxyl groups. Typically the HO—B—OH is a diol or a hydroxyl-capped prepolymer such as a polyurethane, polyester, polyamide, or polyurea prepolymer.

Examples of useful polyols include, but are not limited to, polyester polyols (such as lactone polyols), polyether polyols (such as polyoxyalkylene polyols), polyalkylene polyols, mixtures thereof, and copolymers therefrom. Polyester polyols are particularly useful. Among the useful polyester polyols useful are linear and non-linear polyester polyols including, for example, polyethylene adipate, polybutylene succinate, polyhexamethylene sebacate, polyhexamethylene dodecanedioate, polyneopentyl adipate, polypropylene adipate, polycyclohexanedimethyl adipate, and poly ε-caprolactone. Particularly useful are aliphatic polyester polyols available from King Industries, Norwalk, Conn., under the trade name “K-FLEX” such as K-FLEX 188 or K-FLEX A308. Examples of suitable higher polyols include, for example, polycaprolactone triols such TONE 0305, TONE 0301 and TONE 0310, available from Union Carbide; polyester triols such as butylene adipate triols; polyether triols such as the polypropylene oxide) adduct of trimethylol propane known as LHT-240, from Union Carbide and polyisopropylene oxides such as ARCOL E-2306 (MW 6,000) from ARCO; and simple triols such as trimethylolpropane and glycerol. Tetrafuctional or higher alcohols such as pentaerythritol may also be useful. It is also foreseen that mixtures of various triols may be utilized.

Where HO—B—OH is a hydroxyl-capped prepolymer, a wide variety of precursor molecules can be used to produce the desired HO—B—OH prepolymer. For example, the reaction of polyols with less than stoichiometric amounts of diisocyanates can produce a hydroxyl-capped polyurethane prepolymer. Examples of suitable diisocyanates include, for example, aromatic diisocyanates, such as 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate), methylenediphenylene-4,4′-diisocyanate, polycarbodiimide-modified methylenediphenylene diisocyanate, (4,4′-diisocyanato-3,3′,5,5′-tetraethyl) biphenylmethane, 4,4′-diisocyanato-3,3′-dimethoxybiphenyl, 5-chloro-2,4-toluene diisocyanate, 1-chloromethyl-2,4-diisocyanato benzene, aromatic-aliphatic diisocyanates such as m-xylylene diisocyanate, tetramethyl-m-xylylene diisocyanate, aliphatic diisocyanates, such as 1,4-diisocyanatobutane, 1,6-diisocyanatohexane (hexamethylene diisocyanate), 1,12-diisocyanatododecane, 2-methyl-1,5-diisocyanatopentane, and cycloaliphatic diisocyanates such as methylene-dicyclohexylene-4,4′-diisocyanate, and 3-isocyanatomethyl-3,5,5-trimethyl-cyclohexyl isocyanate (isophorone diisocyanate). For reasons of weatherability, generally aliphatic and cycloaliphatic diisocyanates are used.

An example of the synthesis of a HO—B—OH prepolymer is shown in Reaction Scheme 1 (where (CO) represents a carbonyl group C═O, and R¹ and R² are alkylene, arylene, or related groups) below:

HO—R′—OH+OCN—R²—NCO→HO—R¹—O—[(CO)N—R²—N(CO)O—R¹—O—]ₙH Reaction Scheme 1

where n is one or greater, depending upon the ratio of polyol to diisocyanate, for example, when the ratio is 2:1, n is 1. Similar reactions between polyols and dicarboxylic acids or dianhydrides can give HO—B—OH prepolymers with ester linking groups.

In some embodiments, the polyol is an aliphatic polyester polyol such as those available from King Industries, Norwalk, Conn., under the trade name “K-FLEX” such as K-FLEX 188 or K-FLEX A308.

A wide variety of polyisocyanates may be used. The term polyisocyanate includes isocyanate-functional materials that generally comprise at least 2 terminal isocyanate groups. Polyisocyanates include diisocyanates (materials with 2 terminal isocyanate groups) and higher polyisocyanates such as triisocyanates (materials with 3 terminal isocyanate groups), tetraisocyanates (materials with 4 terminal isocyanate groups), and the like. Typically the reaction mixture contains at least one higher isocyanate if a difunctional polyol is used. Higher isocyanates are particularly useful if crosslinked polyurethane polymers are desired. Diisocyanates may be generally described by the structure OCN—Z—NCO, where the Z group may be an aliphatic group, an aromatic group, or a group containing a combination of aromatic and aliphatic groups. Examples of suitable diisocyanates include, for example, aromatic diisocyanates, such as 2,6-toluene diisocyanate, 2,5-toluene diisocyanate, 2,4-toluene diisocyanate, m-phenylene diisocyanate, p-phenylene diisocyanate, methylene bis(o-chlorophenyl diisocyanate), methylenediphenylene-4,4′-diisocyanate, polycarbodiimide-modified methylenediphenylene diisocyanate, (4,4′-diisocyanato-3,3′,5,5′-tetraethyl) biphenylmethane, 4,4′-diisocyanato-3,3′-dimethoxybiphenyl, 5-chloro-2,4-toluene diisocyanate, 1-chloromethyl-2,4-diisocyanato benzene, aromatic-aliphatic diisocyanates such as m-xylylene diisocyanate, tetramethyl-m-xylylene diisocyanate, aliphatic diisocyanates, such as 1,4-diisocyanatobutane, 1,6-diisocyanatohexane (hexamethylene diisocyanate), 1,12-diisocyanatododecane, 2-methyl-1,5-diisocyanatopentane, and cycloaliphatic diisocyanates such as methylene-dicyclohexylene-4,4′-diisocyanate, and 3-isocyanatomethyl-3,5,5-trimethyl-cyclohexyl isocyanate (isophorone diisocyanate). For reasons of weatherability, generally aliphatic and cycloaliphatic polyisocyanates are used.

If difunctional polyols are used, higher functional polyisocyanates, such as triisocyanates, typically are used to create a crosslinked polyurethane polymer layer. Triisocyanates include, but are not limited to, polyfunctional isocyanates, such as those produced from biurets, isocyanurates, adducts, and the like. Some commercially available polyisocyanates include portions of the DESMODUR and MONDUR series from Bayer Corporation, Pittsburgh, Pa., and the PAPI series from Dow Plastics, a business group of the Dow Chemical Company, Midland, Mich. Particularly useful triisocyanates include those available from Bayer Corporation under the trade designations DESMODUR N3300A and MONDUR 489. One particularly suitable aliphatic polyisocyanate is DESMODUR N3300A.

A wide range of polyol and polyisocyanate combinations may be used to produce the structured polyurethane layer of this disclosure. For purposes of weatherability it is generally desirable to select aliphatic materials. Additionally, in order to retain the desired structure over time, it may be desirable that the structured polyurethane layer be crosslinked. This crosslinking may be achieved by the selection of materials (i.e. at least one of the polyol and polyisocyanate has a functionality greater than 2) and/or may be achieved by a post-curing process such as exposure to an electron beam (E-beam crosslinking)

The reactive mixture used to form the structured polyurethane layer also contains a catalyst. The catalyst facilitates the step-growth reaction between the polyol and the polyisocyanate. Conventional catalysts generally recognized for use in the polymerization of urethanes may be suitable for use with the present disclosure. For example, aluminum-based, bismuth-based, tin-based, vanadium-based, zinc-based, or zirconium-based catalysts may be used. Tin-based catalysts are particularly useful. Tin-based catalysts have been found to significantly reduce the amount of outgassing present in the polyurethane. Most desirable are dibutyltin compounds, such as dibutyltin diacetate, dibutyltin dilaurate, dibutyltin diacetylacetonate, dibutyltin dimercaptide, dibutyltin dioctoate, dibutyltin dimaleate, dibutyltin acetonylacetonate, and dibutyltin oxide. In particular, the dibutyltin dilaurate catalyst DABCO T-12, commercially available from Air Products and Chemicals, Inc., Allentown, Pa. is particularly suitable. The catalyst is generally included at levels of at least 200 ppm or even 300 ppm or greater.

The aliphatic polyurethanes show good stability to ultraviolet weathering, but the addition of UV stabilizers can further improve their stability when exposed to the environment. Examples of suitable UV stabilizers include Ultraviolet absorbers (UVAs), Hindered Amine Light Stabilizers (HALS), and antioxidants. Combinations of these UV stabilizers may also be used. It has been found useful to choose additives that are soluble in the reactive mixture, especially in the polyol. Benzotriazole UVAs such as the compounds TINUVIN P, 213, 234, 326, 327, 328, and 571 available from Ciba, Tarrytown, N.Y.; hydroxylphenyl triazines such as TINUVIN 400 and 405 available from Ciba, Tarrytown, N.Y.; HALS such as TINUVIN 123, 144, 622, 765, 770 available from Ciba, Tarrytown, N.Y.; and the antioxidants IRGANOX 1010, 1135 and 1076 available from Ciba, Tarrytown, N.Y., are particularly useful. The material TINUVIN B75, a product containing UVA, HALS and antioxidant available from Ciba, Tarrytown, N.Y. is also suitable.

The reactive mixture used to form the structured polyurethane layer may also contain additional additives if desired as long as the additive does not interfere with the urethane polymerization reaction or adversely affect the optical properties of the formed structured polyurethane layer. Additives may be added to aid the mixing, processing, or coating of the reactive mixture or to aid the final properties of the formed Fresnel lens. Examples of additives include: particles, including nanoparticles or larger particles; mold release agents; antimildew agents; antifungal agents; antifoaming agents; antistatic agents; and coupling agents such as amino silanes and isocyanato silanes. Combinations of additives can also be used.

A variety of methods can be employed to prepare the Fresnel lenses of this disclosure. For example a laminate structure comprising a transparent substrate, a reactive mixture and a structuring tool can be prepared, the reactive mixture can be polymerized to form the structured polyurethane layer, and the structuring tool can be removed. Alternatively the structured polyurethane layer could be prepared separately and then bonded to the transparent substrate.

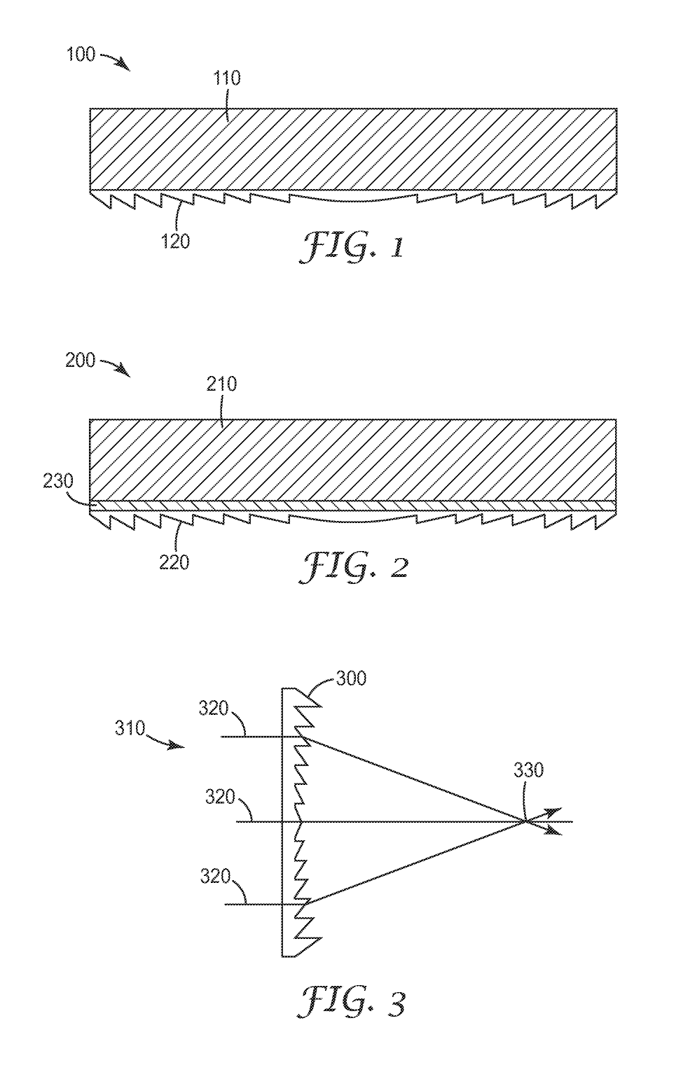

An example of a Fresnel lens prepared from the method in which a laminate structure comprising a transparent substrate, a reactive mixture and a structuring tool is prepared, the reactive mixture is polymerized to form the structured polyurethane layer, and the structuring tool is removed, is shown in FIG. 1. In FIG. 1, Fresnel lens 100 comprises transparent substrate 110 and structured polyurethane layer 120. An example of a Fresnel lens in which the structured polyurethane layer is prepared separately and then bonded to the transparent substrate is shown in FIG. 2. In FIG. 2, Fresnel lens 200 comprises transparent substrate 210 and structured polyurethane layer 220 with bonding layer 230 located between transparent substrate 210 and structured polyurethane layer 220.

A variety of different embodiments can be prepared by preparing a laminate structure comprising a transparent substrate, a reactive mixture and a structuring tool prior to curing of the reactive mixture. For various reasons it may be desirable in some embodiments to apply the reactive mixture to the transparent substrate and in other embodiments it may be desirable to apply the reactive mixture to the structuring tool.

In some embodiments the Fresnel lens is prepared by applying a reactive mixture layer to the transparent substrate and creating the structured polyurethane layer on the transparent substrate. This process can be achieved in a variety of different ways that typically will include the steps of supplying a transparent substrate, preparing a reactive mixture, applying the reactive mixture to the transparent substrate, applying a structuring tool to the reactive mixture, polymerizing the reactive mixture and removing the tool to form the structured polyurethane layer on the transparent substrate.

Each of these steps may involve a variety of processes. For example, the step of supplying the transparent substrate may also involve additional steps such as cleaning, drying, and surface modification of one or both of the major surfaces of the substrate. As described above, a variety of surface modifications may be useful or desirable to modify the properties of the transparent substrate. These steps may be done sequentially or simultaneously. In some embodiments it may be desirable to apply a primer coating to the transparent substrate on the side on which the structured polyurethane layer will reside to aid in the adhesion of the structured polyurethane layer to the substrate surface. Examples of primer coatings include, for example, the application of coupling agents such as an amino silane coupling agent.

The reactive mixture is generally supplied in the desired stoichiometric ratio and is well mixed prior to delivery to the substrate or tooling. Any suitable system that enables the flowable material to be dispensed may be used. Suitable pumps for this process include, for example, a peristaltic pump, a linear drive pump, a manually activated pump, or a pressure pot. Suitable mixers include, for example, static mixers and rotating mixers. Systems that limit residence time are desirable with curing reactive mixtures.

The reactive mixture may be applied to the surface of the transparent substrate to form a reactive mixture layer by a variety of different techniques. Typically the reactive mixture is applied via a coating technique. Examples of coating techniques include gravure coating, curtain coating, slot coating, spin coating, screen coating, transfer coating, brush or roller coating, spray coating, and inkjet printing, hot melt coating, and the like. Because the mixture to be coated is reactive, hot melt coating may be problematic, however, reactive extrusion can be used to produce polyurethane polymers and therefore such reactive extrusion techniques are within the scope of this disclosure.

The reactive mixture may be applied to form a continuous or discontinuous layer and may be of variety of thicknesses. In particular, the reactive mixture can be applied in a discontinuous fashion to form discrete coated regions. These discrete coated regions can be used to form an array of Fresnel lenses on a single substrate. Additionally, an array of substrates can be used. Typically, the reactive mixture is applied to a thickness of at least 10 micrometers.

A structuring tool is applied to at least a portion of the reactive mixture layer. The structuring tool can take a variety of forms and may be a discrete tool or a continuous tool. Examples of discrete tools include for example molds, forms, and the like. Examples of continuous tools include structured liners and tooling films. The tools can be made from a variety of different materials and by a variety of different techniques that are practiced in, for example, the structuring and microstructuring art. Examples of suitable materials for tools include metals and polymeric materials. The surface of the tool may contain a surface coating, such as for example, a release coating to aid in the removal of the tool from the cured polyurethane layer.

The structuring tool will have features which are the opposite of the features on the structured polyurethane layer. For example, if it is desired that the structured polyurethane layer have a protrusion, the tool will have a corresponding depression. The size of the features of the structuring tool correspond to the size of features on the structured polyurethane layer, namely, at least one of the feature dimensions (height, width and length) is greater than 10 micrometers. Two or even all three of the feature dimensions (height, width, length) may be greater than 10 micrometers. The structures may additionally comprise features of less than 10 micrometers.

In some embodiments the tool is a tooling film. Tooling films are films containing structures which can be contacted to or filled with a curable reaction mixture. Typically the tooling films are prepared from organic polymeric materials such as polyacrylics, polyolefins polyesters, polysilicones, and the like. The tooling films may also contain surface coatings or layers to enhance the release of the structured polyurethane layer from the tooling film after the polyurethane layer is cured. Typically the tooling film contains features where at least one of the feature dimensions (height, width and length) is greater than 10 micrometers and less than 1 millimeter.

After the tool has been applied to the reactive mixture layer, the reactive mixture layer can be cured to give the structured polyurethane layer. Typically the reactive mixtures cure at room temperature. If desired, heat can be applied to the reactive mixture to accelerate curing. Heat may be applied indirectly to the reactive mixture through the use of an oven such as a forced air oven or directly to the polyurethane layer through the use of a infrared lamp or a heat gun. Typically an oven is used. Generally the reactive mixture is cured at room temperature for about 6-8 hours or overnight. The rate of curing can also be affected by the level of catalyst used, increasing the catalyst amount can accelerate curing. Additionally, especially if crosslinking of the polyurethane polymer is desired, the cured reactive mixture can be subjected to post-curing processing, such as exposure to electron beams to form crosslinks.

Once curing has been completed the tooling is removed. Techniques used to remove the tool will depend upon the type of tool used, the composition of the tool, the desirability of re-using the tool and the like. Typically, in embodiments using tooling film, the film is peeled away from the polyurethane layer to reveal the structured polyurethane layer.

In an alternative embodiment, it may in some instances be desirable to apply the reactive mixture to the tool instead of to the transparent substrate. The reactive mixture could be applied to the tool in a variety of ways such as the coating techniques described above. In these embodiments, the combined reactive mixture and tool could then be applied to the transparent substrate. There are several reasons why this technique may be desirable. For example, if relatively large structures are to be formed in the polyurethane layer it may be easier for the reactive mixture to be applied to the structured tool and be allowed to fill the space in the tool rather than have the tool be applied to a coated layer. Additionally, depending upon the viscosity of the reactive mixture it may be desirable to allow the reactive mixture to flow into and fully fill the spaces of the tool, rather than to apply to the tool to a pre-coated layer.

After applying the reactive mixture to the tool, the combined reactive mixture and tool assembly can be contacted to the transparent substrate such that at least a portion of the reactive mixture contacts the surface of the transparent substrate. Curing and removal of the tool can be carried out as described above.

In some embodiments it may be desirable to pre-make the structured polyurethane layer and adhere it to the surface of transparent substrate. The same types of structured tools can be used as were described above, except that in these embodiments the reactive mixture is cured in the tooling without contacting the transparent substrate. Curing can be carried out as described above. Typically, the structured polyurethane layer is retained in the tool until it is adhered to the transparent substrate, although it may be possible in some embodiments to remove the structured polyurethane layer from the tool prior to adhering it to the transparent substrate.

The structured polyurethane layer is typically adhered to the transparent substrate through the use of an adhesive. The adhesive may take a variety of forms including pressure sensitive adhesives, heat activated adhesives as well as structural adhesives. It is desirable to select an adhesive which will adhere the structured polyurethane layer to the transparent substrate without interfering with the optical properties of the formed Fresnel lens. Generally, useful structural adhesives contain reactive materials that cure to form a strong adhesive bond to the transparent substrate and the structured polyurethane layer. The structural adhesive may cure spontaneously upon mixing (such as a 2 part epoxy adhesive) or upon exposure to air (such as a cyanoacrylate adhesive) or curing may be effected by the application of heat or radiation (such as UV light). Examples of suitable structural adhesives include epoxies, acrylates, cyanoacrylates, urethanes, and the like. In some embodiments it may be desirable to use the same reactive mixture used to prepare the structured polyurethane layer as the adhesive. One advantage is the compatibility the cured polyurethane layer can have for the reactive mixture used to form it.

Examples of suitable heat activated adhesives and pressure sensitive adhesives include for example, natural rubber adhesives, synthetic rubber adhesives, styrene block copolymer adhesives, polyvinyl ether adhesives, acrylic adhesives, poly-α-olefin adhesives, silicone adhesives, urethane adhesives or urea adhesives.

The adhesive, whether structural, heat activated or pressure sensitive, can be applied either to the transparent substrate or to the cured structured polyurethane layer. The adhesive can be applied through a variety of coating techniques such as gravure coating, curtain coating, slot coating, spin coating, screen coating, transfer coating, brush or roller coating, spray coating, and inkjet printing, hot melt coating, and the like to form an adhesive layer. The adhesive layer may be continuous or discontinuous. If a heat activated adhesive is used, heat can be applied to enhance the tack of the adhesive layer. If the adhesive layer is present on the transparent substrate, the cured structured polyurethane layer is applied to the adhesive layer. If the adhesive layer is present on the cured structured polyurethane layer, the transparent substrate is contacted to the adhesive layer. In some embodiments it may also be desirable to apply adhesive to both the transparent substrate surface and to the cured structured polyurethane layer surface.

There are variety of different reasons why preparing the cured structured polyurethane layer separate from the transparent substrate may be desirable. For example, it may be possible to form the structured polyurethane layer using a continuous tool such as a structured liner or tooling film which can permit arrays of structured polyurethane layer units or structured polyurethane layers of various sizes to prepared simultaneously. It can be more difficult and time consuming to include the use of transparent substrates in this step. Additionally, this permits the cured structured polyurethane layer to be prepared at one location and time and the Fresnel lens comprising a transparent substrate and a structured polyurethane layer to be completed at a different location and time.

The Fresnel lenses of this disclosure can be used for a wide range of applications. Among the suitable applications are light-gathering applications such as are typical for positive lenses and light spreading applications such as are typical for negative lenses. Examples of light-gathering applications include the concentration of sunlight in a solar power generation system, and the generation of parallel light in the direction of light entering the lens for backlighting of liquid crystal displays. Examples of light spreading applications include, for example, the use of a light spreading lens in illuminated signs where a single light source can replace multiple light sources. The description below deals with positive Fresnel lenses, but the description is equally applicable to case of negative Fresnel lenses.

Because of the flexibility of the methods of preparing the Fresnel lenses of this disclosure, panel arrays of Fresnel lenses can readily be prepared. For example, a plurality of structured polyurethane layers can be prepared as described above and adhered to a single transparent substrate or to a plurality of transparent substrates. The plurality of structured polyurethane layers may be the same or different. The lenses may be different in size, shape, etc.

Additionally, a plurality of structured polyurethane layers can be prepared on a single transparent substrate or a plurality of structured substrates using the techniques in which the reactive mixture is either coated onto the substrate or onto the tool and the substrate and the tool are brought together and the reactive mixture cured to form the structured polyurethane layer. Such a process could be done in a batch-wise or in a continuous fashion. An example of a continuous process would be to use a coater, such as a notch bar coater, using a transparent substrate or a plurality of transparent substrates as the bottom layer and a tooling film as the top layer. The reactive mixture could be introduced continuously onto the transparent substrate layer and tooling film pressed onto this coating as the bottom layer is passed through the coater.

The Fresnel lenses of this disclosure are particularly suitable to function as light-gathering lenses for solar power generating systems. As shown in FIG. 3, light rays 320 are incident on the flat side 310 of Fresnel lens 300 and are focused on focal point 330. The Fresnel lenses of this disclosure can also be line-focus lenses.

Solar power generation systems utilize solar light to generate power. Unfocussed solar light is inefficient in power generation, so Fresnel lenses are used as solar collectors to focus solar light onto a solar light convertor which converts solar light into energy. In some instances the solar power generation systems contain photovoltaic cells which convert solar radiation to electric current. To improve the efficiency of the photovoltaic cells, Fresnel lenses are used to focus the incoming solar light onto these photovoltaic cells. In other instances the solar power generation systems utilize the Fresnel lens to concentrate light on a device which absorbs the focused solar light and converts it into heat.

Solar power generation systems are used in a wide array of applications, both earth-bound applications and space-based applications. Many of these environments are very hostile to organic polymeric materials. In addition, larger and larger solar power generation systems are being developed which require lenses that not only can be cheaply, quickly and reproducibly made, but also can withstand the challenging environments to which the lenses are exposed.

One feature that makes the Fresnel lenses of this disclosure particularly suitable for use as light-gathering lenses for solar power generating systems is their weatherability. Lenses that are exposed to the outside environment are susceptible to a variety of detrimental conditions. For example, exposure to the outside environment exposes the lens to the elements such as rain, wind, hail, snow, ice and the like which can damage the lens. In addition, long term exposure to heat and UV exposure from the sun can also cause degradation of the lens. Polymeric organic materials are susceptible to breakdown upon repeated exposure to UV radiation. This breakdown has been observed as yellowing of polycarbonate materials, for example, as is reported in the journal article “Evaluation of Commercial Polycarbonate Optical Properties after QUV-A Radiation—The Role of Humidity in Photodegradation” by G. F. Tjandraatmadja, L. S. Burn, and M. C. Jollands in Polymer Degradation and Stability, Volume 78, 2002, Pages 435-448. This report states that a 1 millimeter film of LEXAN 8010 bisphenol A polycarbonate yellows substantially after exposure to about 100 MJ/m² (300-400 nm radiation).

Weatherability for devices such as solar power generating systems is generally measured in years, because it is desirable that the materials be able to function for years without deterioration or loss of performance. It is desirable for the materials to be able to withstand up to 20 years of outdoor exposure without significant loss of optical transmission or mechanical integrity. Many polymeric organic materials are not able to withstand outdoor exposure without loss of optical transmission or mechanical integrity for extended periods of time, such as 20 years.

The weatherability of the lenses of this disclosure is enhanced both by the design of the lens and by the materials selection of the lens. The lenses are designed, when used as, for example, solar collectors, to have the flat, transparent substrate side of the lens exposed to the outside environment. This configuration protects the structured polyurethane layer from physical damage from exposure to the elements, rain, dust, wind, hail, and the like. In addition, the choice of polyurethane materials for the structured layer of the lens improves the weatherability due to the resistance of the polyurethane materials to breakdown upon repeated exposure to UV radiation. Typically, the structured polyurethane layer comprises an aliphatic polyurethane because polyurethanes that contain aromatic molecules can yellow over time due to exposure to UV radiation. Additionally, at least one UV stabilizer is present in the structured polyurethane layer to further enhance the weatherability. In some embodiments a combination of UV stabilizers are used.

Because it is not possible to test materials by exposure to 20 years of outdoor exposure, various testing protocols have been developed to mimic exposure of materials to the environment, especially to UV radiation from sunlight. Exposure of materials, especially lenses, to doses of UV radiation for extended periods of time and determination of the change of transmission of light through the material is an example of the types of testing that can be used to mimic exposure of materials to the environment. An example of such a test is ASTM G155-05a “Standard Practice for Operating Xenon Arc Light Apparatus for Exposure of Non-Metallic Materials”.

In some embodiments, the Fresnel lenses of the present disclosure display weatherability such that, upon exposure to cumulative UV radiation in the 300-400 nm range of 2,916 MJ/m², the change in the % Transmission of the lens at 500 nanometers is less than 4%. In some embodiments, the change in the % Transmission of the lens at 500 nanometers may be less than 2%, or even less than 1%.

### EXAMPLES

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company; Milwaukee, Wis. unless otherwise noted.

Table of Abbreviations

| Abbreviation or | |
|---|---|
| Trade Designation | Description |
| Polyol-1 | Aliphatic polyester polyol, commercially available from King |
| | Industries, Norwalk, CT, under the trade name “K-FLEX 188”. |
| Polyisocyanate-1 | Aliphatic polyisocyanate, commercially available from Bayer, |
| | Pittsburgh, PA, under the trade name “DESMODUR N3300A”. |
| Catalyst | Dibutyltin dilaurate catalyst, commercially available from Air Products |
| | and Chemicals, Inc., Allentown, PA, under the trade name “DABCO T-12”. |
| Additive-1 | UV Hindered Amine Light Stabilizer (HALS), commercially available |
| | from Ciba, Hawthorne, NY, under the trade name “TINUVIN 123”. |
| Additive-2 | UV light absorber, commercially available from Ciba, Hawthorne, NY, |
| | under the trade name “TINUVIN 405”. |
| Coupling Agent | 3-aminopropyl-trimethoxysilane, commercially available from |
| | Momentive Performance Materials, Albany, NY, as “SILQUEST A-1170”. |
| Tooling Film | A micro-replicated acrylic Fresnel lens film with a thickness of 711 |
| | micrometers (0.028 inches), commercially available from 3M |
| | Company, St. Paul, MN. |
| Glass Substrate | Glass plate of 6.35 centimeters (2.5 inches) × 13.02 centimeters (5.125 |
| | inches). |

### Test Methods

### Accelerated UV Testing

Samples were tested for accelerated UV aging according to ASTM G155-05a. Results are presented as percent transmission values (% T) at 500 nm after total accumulated UV exposure levels of MegaJoules per square meter of surface (MJ/m²) in the 300-400 nm radiation range. From the measured % Transmission values, a % change from the initial (cumulative exposure of zero) % Transmission was calculated using the formula:

(Initial%T−Current%T)/Initial%T×100%.

### Preparation of Reactive Mixture

In an air mixer at 93° C. were mixed 47.0 grams of Polyol-1, and 2.0 grams of Additive-2 with 1.0 gram of Additive-1, and 4 drops of Catalyst. To reduce the resultant air bubbles, the mixture was then placed in a vacuum oven overnight at 60° C. To 7.6 grams of the above resin mixture was mixed 6.0 grams of Polyisocyanate-1 and 1 drop of Catalyst. The reactive mixture was used within 5 minutes of mixing in Polyisocyanate-1 and the last drop of Catalyst.

### Preparation of Primed Glass Substrate

A Glass Substrate was primed with a solution of 10% Coupling Agent, and 90% isopropanol. This solution was poured directly onto the glass and spread around with a cloth. The resulting slightly hazy coating was buffed with a clean cloth until clear. The coating was left overnight to cure completely.

### Example 1

### Single Lens Fabrication

A sample of the Reactive Mixture prepared above was poured onto a piece of Tooling Film and the mixture was smoothed out to form a uniform fill. The resulting coated film was laminated by hand onto a primed Glass Substrate. The construction was left overnight to cure. The tooling film was then removed by hand. Sample lenses were tested for Accelerated UV Aging using the test method described above. Resulting transmission values at 500 nm are presented in Table 1 for the total accumulated UV exposure levels in the 300-400 nm range, as well as % change from the initial % T value.

### Example 2

### Lens Panel Fabrication

Tooling Film was brought into a notch bar coater as the top film, with the micro-replicated pattern facing down. Primed Glass Substrates were brought into the nip position on the coater as the bottom layer. The Reactive Mixture prepared above was mixed with a two part mixing gun (commercially available form ConProTec, Inc., Salem, N.H.) to the proper ratios and continuously poured onto the bottom glass so as to establish a rolling bank of Reactive Mixture on the input side of the notch bar. By advancing the micro-replicated tooling and the glass through the coater at the same rate, a sandwich construction was formed with the uncured Reactive Mixture between the glass and the tooling film. This construction was left at room temperature overnight to cure. The tooling film was then removed by hand. Sample lenses were tested for Accelerated UV Aging using the test method described above. Resulting transmission values at 500 nm are presented in Table 1 with the total accumulated UV exposure levels in the 300-400 nm range, as well as % change from the initial % T value.

TABLE 1

| Total | | Ex. 1 | | Ex. 2% |
|---|---|---|---|---|
| Accumulated | Ex. 1 | % Change | Ex. 2 | Change |
| UV Exposure | (% T at | from Initial | (% T at | from Initial |
| (MJ/m²) | 500 nm) | Transmission | 500 nm) | Transmission |
| 0 | 90.7 | 0 | 90.7 | 0 |
| 486 | 88.3 | 2.64 | 87.1 | 3.97 |
| 972 | 89.4 | 1.43 | 89.4 | 1.43 |
| 1,458 | 89.5 | 1.32 | 89.5 | 1.32 |
| 1,944 | 90.6 | 0.11 | 90.1 | 0.66 |
| 2,430 | 90.5 | 0.22 | 90.2 | 0.55 |
| 2,916 | 90.3 | 0.44 | 90.0 | 0.77 |

1. A Fresnel lens comprising:
a transparent substrate; and
a structured polyurethane layer, wherein the structured polyurethane layer comprises:
an at least partially cured reaction mixture wherein the reaction mixture comprises:
a polyol;
a polyisocyanate;
a catalyst; and
at least one UV stabilizer.

2. The Fresnel lens of claim 1, wherein the transparent substrate comprises glass, polymethylmethacrylate, polycarbonate, polyamide, polyester, or a polycyclic olefin copolymer.

3. The Fresnel lens of claim 1, wherein the structured polyurethane layer comprises an aliphatic polyurethane.

4. The Fresnel lens of claim 1, wherein the lens comprises a planar or a non-planar Fresnel lens.

5. The Fresnel lens of claim 1, wherein the Fresnel lens comprises a positive Fresnel lens.

6. The Fresnel lens of claim 5, wherein the Fresnel lens comprises a point focus Fresnel lens or a line-focus Fresnel lens.

7. The Fresnel lens of claim 1, wherein the Fresnel lens comprises a negative Fresnel lens.

8. (canceled)

9. The Fresnel lens of claim 1, wherein the at least one UV stabilizer is selected from a UV Absorber (UVA), a Hindered Amine Light Stabilizer (HALS), an antioxidant, or combinations thereof.

10. The Fresnel lens of claim 1, wherein the structured polyurethane layer further comprises at least one additional additive selected from particles, mold release agents, antimildew agents, antifungal agents, antifoaming agents, antistatic agents, coupling agents and combinations thereof.

11. (canceled)

12. The Fresnel lens of claim 1, wherein the Fresnel lens upon exposure to 2,916 MJ/m² of cumulative UV radiation in the range of 300-400 nanometers has a change in the % Transmission of the lens at 500 nanometers of less than 1%.

13. The Fresnel lens of claim 1, wherein the structured polyurethane layer is crosslinked.

14. A method of preparing a Fresnel lens comprising:
providing a transparent substrate with a first surface and a second surface;
providing a curable reaction mixture comprising:
a polyol;
a polyisocyanate;
a catalyst; and
at least one UV stabilizer;
providing a structuring tool;
preparing a transparent substrate, curable reaction mixture laminate construction;
curing the reaction mixture; and
removing the structuring tool.

15. The method of claim 14, wherein preparing a transparent substrate, curable reaction mixture laminate construction comprises:
coating the curable reaction mixture on at least a portion of the first surface of the transparent substrate; and
contacting a structuring tool to at least a portion of the coated curable reaction mixture.

16. The method of claim 14, wherein preparing a transparent substrate, curable reaction mixture laminate construction comprises:
coating the curable reaction mixture on at least a portion of the structuring tool; and
contacting the first surface of the transparent substrate to at least a portion of the coated curable reaction mixture.

17. (canceled)

18. The method of claim 14, wherein the curable reaction mixture comprises an aliphatic polyol and an aliphatic polyisocyanate.

19. (canceled)

20. The method of claim 14, wherein the Fresnel lens comprises a positive Fresnel lens.

21. (canceled)

22. A method of preparing a Fresnel lens comprising:
providing a curable reaction mixture comprising:
a polyol;
a polyisocyanate;
a catalyst; and
at least one UV stabilizer;
providing a structuring tool with a structured surface;
contacting the curable reaction mixture to the structured surface of the structuring tool;
curing the reaction mixture;
providing a transparent substrate with a first surface and a second surface;
adhesively bonding the cured reaction mixture to the first surface of the transparent substrate; and
removing the structuring tool.

23. The method of claim 22, wherein adhesively bonding comprises: application of a pressure sensitive adhesive to at least a portion of the cured reaction mixture and contacting the cured reaction mixture to the first surface of the transparent substrate; application of a pressure sensitive adhesive to at least a portion of the first surface of the transparent substrate and contacting the cured reaction mixture to the first surface of the transparent substrate; application of a curable adhesive material to at least a portion of the cured reaction mixture, contacting the cured reaction mixture to the first surface of the transparent substrate, and curing the curable adhesive material; application of a curable adhesive material to at least a portion of the first surface of the transparent substrate, contacting the cured reaction mixture to the first surface of the transparent substrate, and curing the curable adhesive material; or a combination thereof.

24. (canceled)

25. An optical array comprising:
a plurality of Fresnel lenses, wherein at least one Fresnel lens comprises:
a transparent substrate; and
a structured polyurethane layer, wherein the structured polyurethane layer comprises:
an at least partially cured reaction mixture wherein the reaction mixture comprises:
a polyol;
a polyisocyanate;
a catalyst; and
at least one UV stabilizer.

26. A solar power generation device comprising:
a Fresnel lens comprising:
a transparent substrate; and
a structured polyurethane layer, wherein the structured polyurethane layer comprises:
an at least partially cured reaction mixture wherein the reaction mixture comprises:
a polyol;
a polyisocyanate;
a catalyst; and
at least one UV stabilizer; and
a solar light convertor.
